(19) United States
(12) Patent Application Publication
(10) Pub. No.: US 2011/0308407 A1
(43) Pub. Date: Dec. 22, 2011

(54) ROTATIVE PRINTING MACHINE WITH AUTO-TENSIONABLE RULER

(76) Inventor: Paulo Roberto Lourenco, Parque Novo Mundo (BR)

(21) Appl. No.: 13/124,129

(22) PCT Filed: Oct. 13, 2009
(86) PCT No.: PCT/BR09/00316

§ 371 Date: Sep. 6, 2011

(30) Foreign Application Priority Data
Oct. 14, 2008 (BR) MU-8802293-5

(51) Int. Cl. B41F 15/10

(52) U.S. Cl. 101/115

(57) ABSTRACT

“ROTATIVE PRINTING MACHINE WITH AUTO-TENSIONABLE RULER”, it deals with an auto-tensionable ruler (1) by spring (2) contiguous to the movable bushing (3), both annexed to the main axle (4) that receives by extreme connection (5) the printing paste spilled by holes (6), in order to make possible the scattering of said paste in the interior of the cylinder (7), in this manner making possible the preparation and/or assembly of surplus sets of stamping (CE) outside the machine (M), being the relative position of the said sets demarcated in points of reference (15) in the bushing (8) and in the flange (16) receiver of the cylinder (7).

This Patent of Utility Model request deals with a new “ROTATIVE PRINTING MACHINE WITH AUTO-TENSIONABLE RULER”, notedly used for printing of fabrics in general, using rotative printing machines with micro-perforated cylinders for the making of the prints, with prominence for the micro-perforated cylinder assembled in ruler with the ideal tension to print, containing the baton spreader of the paste on the fabric, becoming in this manner possible to assemble the cylinders, rulers and screens outside of the machine, reducing the time of preparation of the said machine.

Currently the rotative machines to print fabrics that use micro-perforated cylinders for the making of the prints operate with a rotative carpet where the fabric is adhered and, on the fabric, it is located the micro-perforated cylinder drawn with the print to be transferred to the fabric properly said. In the known models, the cylinder is bushing, tensioned and pressured in its extremities for bushings supported in bearings, being moved by motor-reducer sets positioned laterally to the machine, of this way propitiating the tensioning and rotation of the cylinder. In turn, inside the cylinder, it is placed the printing paste and a ruler or steel baton that pressures the paste against the cylinder that spills through the micro-holes, printing the fabric.

With this structure, it is basic that the cylinder turns accurately in the same peripheral rotation of the carpet where the fabric is adhered with the purpose of getting perfect prints. The synchronism required between the carpet and the cylinder demand complex electromechanical mechanisms, of high cost, susceptible the constant breakings and maintenances. How much bigger the assemble of colors to be printed more complex becomes the equipment and devices of control of the cylinders and carpets.

Therefore, the known models have a series of deficiencies and technical limitations, namely:
Complexity of equipments and devices of control;
Possibility of imperfections due the great quantity of involved components;
Operational difficulty—when assembling the machine, after the positioning of the cylinders in the due rabbets, it is necessary to place the internal rulers; tension the cylinders and make all the cylinders fix to that drawing to be printed, demanding time and specialized labor;
The operational cost is elevated, once it is directly proportional to the time expensed in the preparation.

Aware of the inconveniences and technical limitations above displayed, the inventor, active person in the textile segment has created the “ROTATIVE PRINTING MACHINE WITH AUTO-TENSIONABLE RULER” in subject, that basically uses a ruler destined to the reception of the micro-perforated rotative cylinder kept in adequate tension to its ideal functioning, having a specific marking that serves as reference for the right positioning in the machine. In order to guarantee the rotation and the synchronism of the rulers on the carpet and the uniformity of the prints, the belts of the bushings are compressed magnetically on the carpet, generating attrition between the parts, making with that the cylinder follows the said carpet synchronously. The magnetism in the insertion of the carpet with the belt is proceeding from magnets or electromagnets located under the table that attracts said projecting against the carpet. The tension of attraction between the parts is made possible and controlled by the movement of the magnet tablets in the horizontal part to be attracted or in the case of electromagnets, varying the tension of the parts.

With these rulers it is possible to assemble the cylinders outside the machine, being the sets placed in the machine only at the moment of printing. In this way, the preparation of sets of surplus prints with other prints in the reserve rulers becomes viable, making possible the preparation of said sets without the stop of the machine. The change of the tensionable rulers is extremely fast; it is also possible to substitute and to restitute all the rulers at once time, using only one cut with support adjusted for such rulers.

Another great advantage is the way as the tensionable ruler rotates and keeps the congruence of the prints or drawings, by the fact of the ruler contains a lock that demarcates the reference of that cylinder and print related to the belt of the bushing, called of point zero or reference signal.

When the writing of the print or drawing in the micro-perforated cylinder is made, it has a beginning and end of writing, being this parameter used for accomplishment of the reference mark that must be combined with the mark of the belt, guaranteeing thus that, all the times that these cylinders return to the machine, they always are located in the same relative position, preventing the adjustments inherent to the conventional machines.

Once the cylinders are assembled always in the predetermined reference, what guarantees the congruence of the prints and in order to keep them during the stamping, it must have an attrition of the belt against the carpet propitiated by the magnets or electromagnets.

To follow, the innovation will be explained technically, using as base the drawings represented below, of illustrative and not limiting way:

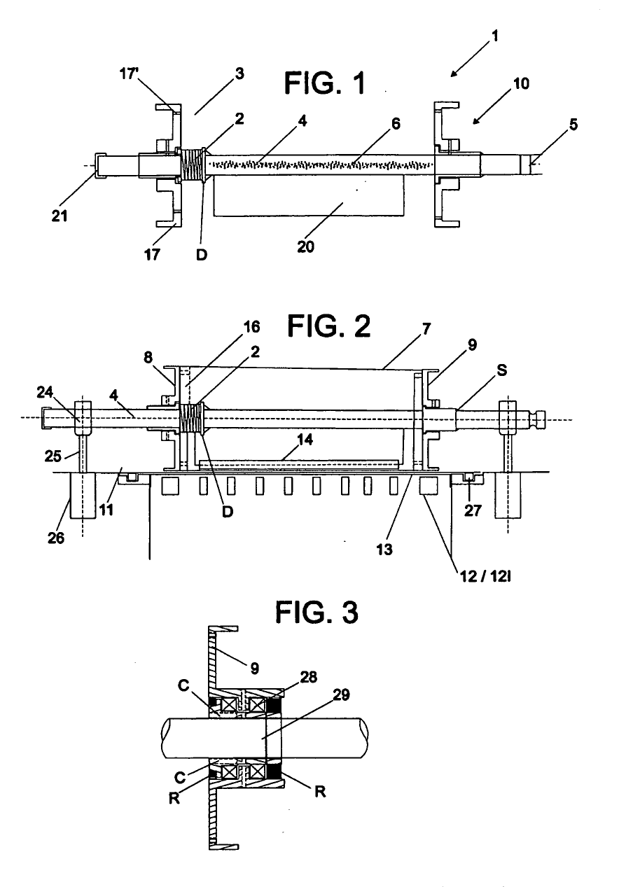

FIG. 1: View in lateral cut of the auto-tensionable ruler;

FIG. 2: Lateral view of the auto-tensionable ruler with the cylinder, assembled in the machine;

FIG. 3: Detail in cut of the bushing that promotes the rotation of the cylinder;

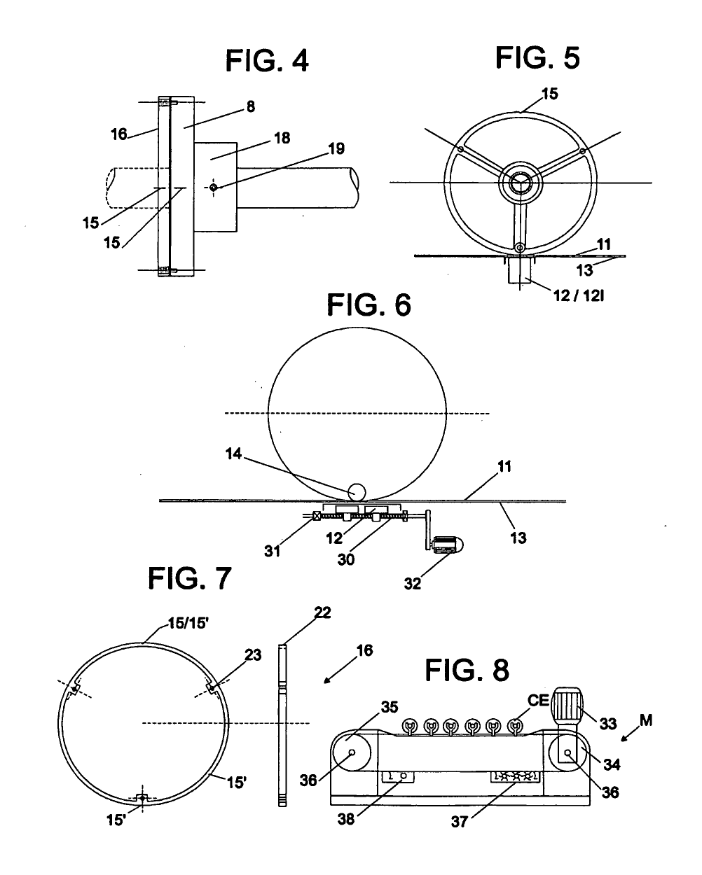

FIG. 4: Superior detail of the bushing that promotes the rotation of the cylinder;

FIG. 5: Lateral view of the bushing/belt that promotes the rotation of the cylinder overlapped to the carpet and table;

FIG. 6: Lateral detail of the magnet or electromagnet used in the belt of the rotative bushing and in the printing baton;

FIG. 7: Lateral view of the flange where the cylinder is connected to frontal detail;

FIG. 8: Lateral view of the machine showed with the ruler and respective cylinder.

“ROTATIVE PRINTING MACHINE WITH AUTO-TENSIONABLE RULER”, object of this Patent of Utility Model request, deals with an auto-tensionable ruler (1) by a spring (2) contiguous to the movable bushing (3), both annexed to the main axle (4) that receives by extreme connection (5) the printing paste spilled by orifices (6) distributed equally throughout its periphery, in order to make possible the scattering of said paste inside the cylinder (7) with the desired print, which is supported in the belt (8) of the movable bushing (3) and in the belt (9) of the fixed bushing (10), abraded in the carpet (11) by magnets (12) or electromagnets (12I) placed below of the table (13), which multiplies to cause magnetic effect in the direction of the baton (14) spreader of paste, making possible the preparation and/or assembly of surplus sets of stamping (CE) outside the machine (M), being the relative position of the sets demarcated in points of reference (15) in the belt (8) and the flange (16) receiver of the cylinder (7).

FIG. 1 shows the auto-tensionable ruler (1) formed by a passer-by axle (4) with holes (6) for passage of the paste, in whose extremity it has a rotative bushing (10) fixed to the axle (4) e, in the opposite extremity, a removable rotative bushing (3) fastened by cotter (C), could be removed of the axle (4) when of the assembly of the cylinder (7), what it makes possible the assembly of sets of stamping (CE) outside the machine (M). The axle (4) presents a spring (2) that keeps the stretching of the cylinder (7) located between the disc (D) fixed in the axle (4) and the removable bushing (3). The axle (4) serves for the conduction of the paste and support of the bushings (3 and 10) that promote the rotation of the cylinder (7). From the bushings (3 and 10) derive the belts (8 and 9) in whose faces (17) the carpet (11) is supported, promoting the rotation of the cylinder (7), being the face (17) coated by a fine layer of soft and antiskid material. The fixed bushing (10) is welded to the axle by weld (S) or another way of setting already known. On the other hand, the belts (8 and 9) have passer-by holes (17′) to transpose screw or lock (not represented) to fix the micro-perforated cylinder (7). The central projections (18) of the belts (8 and 9) have lock pin (19) used to guarantee that the print of that cylinder (7) is, when of the locking, in the correct position of stamping, said pin (19) must be removed when of the operation of the machine, in order to liberate the bushings (3 and 10). Finally, from the axle (4) drift a sideboard plate (20) that directs the stamping paste and keeps the stamping baton (14) in the adequate position. The paste is inserted in the axle (4) through connection (5) and kept in its interior by the opposite tamponage (21).

FIG. 2 shows the assembled cylinder (7) in the flange (16) with perimeter (22) sticked and fastened to the belts (8 and 9) through screws or locks (23) passing in the orifices (17′). Being thus, the set of stamping (CE) is supported in supports (24) connected to the axle (25) of the pistons (26) that adjust to the height of the ruler (1) that facilitates the assembly of the said ruler in the machine (M), as well as approaches or moves away the ruler (1) from the carpet (11), increasing or reducing the contact. For its time, the carpet (11) keeps a uniformity of displacement thanks to lateral guides (27), being overlapped to the table (13) located above of magnets (12) or electromagnets (12I), with the function to facilitate the displacement of the said carpet (11) and to keep the distance between the parts. In the case of electromagnets (12I), the magnetic field is adjusted by the tension applied to the same.

FIG. 3 shows the internal detail of the bushings (3 and 10) and belts (8 and 9) in relation to the axle (4). The belts (8 and 9) turn thanks to the parallel bearings (28) limited in the due positions by lock ring (29), having still retainers that prevent the entrance of liquids or residues in the mobile parts. The removable bushing (3) is imprisoned to the axle by means of cotters. The fixed bushing (10) is welded (S) to the same axle.

FIG. 4 shows the markings of reference (15) so much in the belts (8 and 9) how much in the flanges (16). When assembling the cylinder (7), it must keep the references (15) lined up and the pin (19) locked, since when the print in the cylinder (7) is recorded, it must be taken the care to record all the cylinders (7) always in the same reference, guaranteeing the congruence of the prints.

FIG. 5 shows the bushing (3 or 10) and belts (8 or 9) that promote the rotation of the cylinder. In the belts (8 or 9), the holes (17′) for the screws of union with the flange are denoted (16). In turn, the perimeter reentrance denotes the reference signal (15). This figure shows the carpet (11) that receives the fabric to be printed that slides under the face of the belts (8 or 9) that by magnetism, of the magnet (12) or electromagnet (12I), it follows the movement of the bushing (3 or 10).

FIG. 6 shows the position of magnets (12) in relation to the faces (17) of the belts (8 and 9) in contact with the carpet (11) overlapped to the table (13). Below of the said table (13), the magnets are located (12) that act as much in the faces (17) of the belts (8 and 9) how much throughout the baton (14) of scattering of the paste. The movement of magnets (12) occurs by a screwed spindle (30) supported in bearings (31); this spindle (30) is connected to the motor-reducer set (32).

FIG. 7 shows the flange (16) destined to connect the printing cylinder (7) in the perimeter (22) with chemical adhesive, taking in consideration the mark of reference (15) of the flange in relation to the drawing and when assembled in the belts (8 and 9) it must be considered the marks of assembly of the flange with the marks of the belts (8 and 9) properly said. So that the drawings of the cylinders subsequent to the first one coincide during the process of printing, when of the setting of the cylinder in the flange (16) it must be glue the beginning of the drawing, modifying the measure in relation to the mark of reference (15) of the flange (16). This alteration of measure is proportional to the distance between the centers of the posterior cylinders. In this way, when of the confection of the flanges (16) to be sticked in the cylinders, the marks (15′) for the glue will be already made. Being thus, the flange (16) has two marks (15 and 15′), being the reference mark (15), which must be lined up the mark (15) of the belt in the assembly of the machine and the marks (15′) of glue of the cylinder in the flange, foreseeing the alteration of the measures to promote the rabbet of the drawing.

FIG. 8 shows a series of rulers (1) assembled in the machine (M) with prominence for the motor-reducer (33) activator of the motor pulley (34) that in turn it compels the moved pulley (35), both supported on bearings (36). Below of the carpet (11), it denotes the washer (37) and the applicator (38) of glue that keeps the fabric fixed to the carpet (11) properly said. Of this way, the rulers (1) are easily assembled to the machine (M) with the aid of a cut or winch (not represented).

1. “ROTATIVE PRINTING MACHINE WITH AUTO-TENSIONABLE RULER”, a ruler (1) formed from a passer-by axle (4) with holes (6) for passage of the paste, in whose an extremity it has a rotative bushing (10) fixed to the axle (4) and, in the opposite extremity a removable rotative bushing (3) fixed by cotter (C); the axle (4) presents a spring (2) that keeps the stretching of the cylinder (7) located between the disc (d) fixed in the axle (4) and the removable bushing (3); from the bushings (3 and 10) derive the belts (8 and 9); the fixed bushing (10) is fastened to the axle by weld (S) or another way of setting already known; the central projections (18) of the belts (8 and 9) have lock-pin (19) used to guarantee that the print of that cylinder (7) is, when of the locking, in the correct position of stamping; the set of stamping (CE) is supported in supports (24) connected to the axle (25) of the pistons (26) that adjust the height of the ruler (1) in relation to the carpet (11), increasing or reducing the contact; the carpet (11) keeps a uniformity of displacement thanks to lateral guides (27), being overlapped the table (13), located above of magnets (12) or electromagnets (12I), whose magnetic field is adjusted by the tension applied to the same; the belts (8 and 9) turn thanks to the parallel bearings (28) limited in the due positions for lock ring (29), having still retainers (R); the removable bushing (3) is fastened to the axle by cotters; markings of reference (15) detach as much in the belts (8 and 9) how much in the flanges (16); the flange (16) has two marks (15 and 15′), being the mark of reference (15) which must be lined up to the mark (15) of the bushing in the assembly of the machine and the marks (15′) of glue of the cylinder in the flange, foreseeing the alteration of the measures to promote the rabbet of the drawing; when assembling the cylinder (7), it must be kept the references (15) lined up and the pin (19) locked; below of the related table (13), the magnets (12) are located and act as much in the faces (17) of the belts (8 and 9) how much throughout the baton (14) of scattering of the paste; the movement of magnets (12) occurs by a screwed spindle (30) supported in bearings (31), this spindle (30) is connected to the motor-reducer set (32).
